(19) United States
(12) Patent Application Publication
(10) Pub. No.: US 2002/0112396 A1
(43) Pub. Date: Aug. 22, 2002

(54) Slug trap

(76) Inventor: Anders Nyberg, Hedasgatan 11 (SE)

Correspondence Address: Samuels, Gauthier & Stevens LLP, Suite 3300, 225 Franklin Street, Boston, MA, 02110, US

(21) Appl. No.: 09/969,567

(22) Filed: Oct. 2, 2001

Related U.S. Application Data
(63) Continuation of application No. PCT/SE00/00687, filed on Apr. 10, 2000.

(30) Foreign Application Priority Data
Apr. 9, 1999 (SE) 9901262-7

(51) Int. Cl. A01M 1/10; A01M 1/20

(52) U.S. Cl. 43/121

(57) ABSTRACT

The present invention relates to an attracting bait for snails, in particular Spanish forest snail in order to attract such snails into traps, whereby the bait is based on one or more substances selected from the group of cereals, egg, egg products, sugar, vegetabilic oil, fats, trace minerals and vitamins.

### DESCRIPTION

1. Technical Field

The present invention relates to an attractant for snails, particular Spanish forest snail, Arion lucitanicus, in order to get such snails into traps.

The object of the present invention is to obtain a possibility of catching and thereby be able to render snails harmless, in particular snails of the species Spanish forest snail, in an effective and rational way.

2. Background of the Invention

Spanish forest snail, Arion lucitanicus, more known “killer snail” is a essential noxious animal in gardens and cultivation of vegetables all over Europe, but in particular in Sweden, where the climate factor seems to be optimal for this snail species. Speech forest snail was first found in 1975 in Sweden, but has since then spread explosively over the country and is now found in the whole southern part the country. The growth is presently exponential. Also Norway and Finland are hit, as well as the neighbouring countries south of Sweden. The snail has no natural enemies and thrives well in compost heaps and the similar, where there is some heat which contributes to the hibernation. Compost heaps are also large “nurseries” for the snail.

The spreading of the snail can be stopped by using chalk strings which the snail hates and does not want to pass over, but this is only a primary protection and the chalk will be easily washed away by rain and other moisture. This will not lead to the destruction of the snail, either.

Another way of getting to the snail is to pour salt over it, whereby it falls together completely by necrosis. This means, however, that one has to meet and see the snail, which is not always readily done. It is hardly encouraging non rational to stand watching the cultivation of vegetables, or the mountain poppy plants, with salt to prevent an attack.

The problem is to find an attractant to get the snail into a trap where it dies or can be taken care of and made innoxious.

Tests using beer have been carried out and on the market there is a trap recommending the use of beer to attract Spanish forest snail. The trap has, however, turned out to have a limited effect.

### DESCRIPTION OF THE PRESENT INVENTION

It has now surprisingly turned out possible to be able to solve this problem by means of the present invention, which is characterized in that the bait is based on one or more substances selected from the group of cereals, egg, egg products, sugar, vegetabilic oil, fats, trace minerals and vitamins.

Further characteristics are evident from the accompanying claims.

By means of the present invention it has turned out that one obtains a very great “yield” of Spanish forest snail in a trap baited with such a bait.

The present invention also relates to a snail trap, which comprises a unit to be dug into the ground, which unit has a centrally arranged bait containing container, and a lid releasably arranged over the unit, whereby the lid is arranged to form a slot towards surrounding ground level.

The invention will be described more in detail in the following with reference to some examples and the accompanying drawing, in which

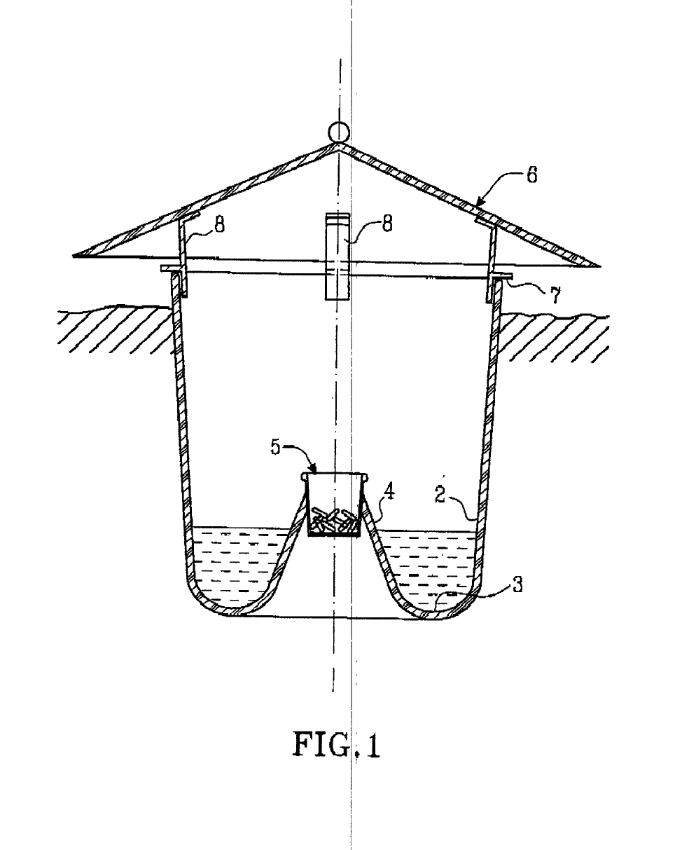

FIG. 1 shows a cross-section along its longitudinal axis of a preferred embodiment of a trap according to the invention.

It has as mentioned above, turned out a bait based on one or more of the substances selected from the group of cereals, egg, egg products, sugar, vegetabilic oil, fats, trace minerals and vitamins.

To this group cereal bran and dry yeast are admitted as well.

The term cereal means primarily wheat, barley, rye, oat, corn, and rice. The term egg products means egg powder. The term vegetabilic oils means common such oils, as rape seed oil, corn oil, olive oil, sun flower seed oil, sesame oil, and other vegetabilic oils. The term fats means primarily vegetabilic fats as generally hydrogenated product of said oils.

The group of trace elements comprises phosphor, calcium, sodium, potassium, magnesium, iron, zinc, copper, manganese and iodine. The group of vitamins comprises vitamin A, vitamin D₃, Vitamin E, vitamin B₁, vitamin B₂, vitamin B₆, nicotine amide, pantothenic acid, vitamin B₁₂.

The amount of carbohydrates, i.e., cereals and sugar can be 0 to 100% by weight of the bait, the amount of egg and egg products can be 0 to 100% by weight of the bait, the amount of oils and fats can be 0 to 100% by weight.

In a combined bait the carbohydrate part is 40 to 60% by weight, oil and fat part is 7 to 20% by weight, and the protein part (egg and egg products) is 10 to 20% by weight, trace elements and vitamins part is 2 to 4% by weight.

The bait can suitably be completed using a cereal bran in an amount of 2 to 10% by weight, and optionally yeast in an amount of about 1% by weight.

The bait is suitably produced as a pelleted bait having a pellet size of 1 to 5 mm. If larger pellets are manufactured these are suitably crushed to increase the active, smell emitting surface.

A such combined bait has turned out to have a superior attracting effect on Spanish forest snail and in a field trial comparing a trap on the market using thereto recommended beer as bait. Thus a trap using a bait according to the present invention trapped 50 Spanish forest snail compared with 5 trapped snails in the trap present on the market using beer as bait.

A suitable trap for catching Spanish forest snails is evident from the accompanying drawing and the description thereof found below.

1 denotes an outer container arranged to be dug into the ground substantially to all its depth. The outer container 1 is thereby substantially cylindrically designed having an open end, whereby the outer container has the measure 250×250 mm. The outer container 1 can, from a production technical standpoint be somewhat conical to facilitate moulding in a plastic moulding equipment. In the outer container 1 there is an inner container 2 arranged, which has essentially the same outer form as the outer container. In the bottom part 3 of the inner container 2 there is a conical holder drawn up which holder 4 is arranged to receive a cup 5. The cup 5 is arranged to receive the bait according to the present invention. Further the inner container 2 provided with a brim 7 at its open end, which brim 7 is intended to rest against the peripheral edge of the outer container 1 and become an entrance plane to the snails being attracted to the trap. In order to prevent other animals and insects to become attracted to the trap and caught therein it is suitably provided with lid/roof 6 extending over the outer edges of the containers 1, 2. The lid/roof 6 which is somewhat conically designed to allow the running off of water is, on its inner side, provided with shoulders 8 arranged to partly stick down into the inner container 2, partly rest on the outer periphery of the inner container 2. The outer container 1 is placed into the ground in such a way that it extends 10 to 20 mm which prevent smaller insects from falling down into the trap. The lid/roof 6 is thereby also placed at the same distance over ground level via its shoulders 8.

The bait according to the present invention is placed in the cup 5 and the space between the cone 4 and the outer walls of the inner container 2 is filled with a liquid to drown the snails which enter the trap. This liquid can suitably consist of beer. It has thereby turned out that beer of the type light beer has a better effect with regard to attraction than beer being more strong with regard to alcoholic strength in combination with the bait of the present invention.

It is apparent that the present invention can be varied the scope of the following claims by the one skilled in the art. Thus the outer container can be eliminated from the trap as well as the amounts of ingoing components of the bait be varied depending of exposure time, exposing temperature, and exposing moisture degree at the use of the bait.

1. Attracting bait for snails, in particular Spanish or snail in order to attract such snails into traps,
characterized in that the bait is based on one or more substances selected from the group of cereals, egg, egg products, sugar, vegetabilic oil, fats, the minerals and vitamins.

2. Attracting bait according to claim 1,
characterized in that it further contains cereal bran ad dry yeast.

3. Attracting bait according to one or more of claims 1-2,
characterized in that the cereal is wheat, barley, rye, oat, corn and rice.

4. Attracting bait according to one or more of claims 1-3,
characterized in that vegetabilic oils and fats are selected from the group of rape seed oil, corn oil, olive oil, sun flower seed oil, sesame oil and their hydrogenated products.

5. Attracting bait according to one or more of claims 1-4,
characterized in that the group of trace elements comprises phosphor, calcium, sodium, potassium, magnesium, iron, zinc, copper, manganese and iodine, and the group of vitamins comprises vitamin A, vitamin D₃, Vitamin E, vitamin B₁, vitamin B₂, vitamin B₆, nicotine amide, pantothenic acid, vitamin B₁₂.

6. Attracting bait according to one or more of claims 1-5,
characterized in that the amount of carbohydrates, i.e., cereals and sugar is 0 to 100% by weight of the bait, the amount of egg and egg products can be 0 to 100% by weight of the bait, the amount of oils and fats can be 0 to 100% by weight.

7. Attracting bait according to one or more of claims 1-6,
characterized in that the carbohydrate part is 40 to 60% by weight, oil and fat part is 7 to 20% by weight, and the protein part (egg and egg products) is 10 to 20% by weight, trace elements and vitamins part is 2 to 4% by weight.

8. Attracting bait according to one or more of claim 2,
characterized in that a cereal bran in an amount of 2 to 10% by weight, and optionally yeast in an amount of about 1% by weight.

9. Trap for Spanish forest snail for utilizing the bait according to claims 1-8,
characterized in that it comprises a container (2) having a conical bottom part (4) for receiving a bait cup (5) and a lid/roof (6) to be arranged over said container (2).

10. Trap according to claim 9,
characterized in that it further comprises an outer container (1) arranged to receive said container (2).
